(19) United States
(12) Patent Application Publication
(10) Pub. No.: US 2014/0372339 A1
(43) Pub. Date: Dec. 18, 2014

(54) METHODS AND SYSTEMS FOR OPTIMIZING PROFITABILITY OF A PRINT PRODUCTION ENVIRONMENT

(71) Applicant: Xerox Corporation, Norwalk, CT (US)

(72) Inventors: Eric Michael Gross, Rochester, NY (US); Tao Wang, Grapevine, TX (US); Sudhendu Rai, Fairport, NY (US)

(21) Appl. No.: 13/920,800

(22) Filed: Jun. 18, 2013

(51) Int. Cl. G06Q 10/06

(52) U.S. Cl. CPC G06Q 10/067
USPC 705/348

(57) ABSTRACT

A method of determining a maximum profit for a print production environment may include receiving, by a computing device, a flow model associated with a print production environment, applying, by the computing device, a modified Jackson Network analysis to the flow model to generate one more characteristic curves that each characterize a relationship between profit of the print production environment and job inflow rate and that each show a maximum profit value for the print production environment, and presenting, by the computing device, one or more of the generated characteristic curves to a user.

### BACKGROUND

Complex business or production processes may include systems having multiple tasks, multiple devices and/or a varied job mix. For such processes, decisions are often made regarding to which device or person a job should be allocated, what job inflow rate is appropriate and/or the like. However, the complexity of such processes makes it difficult to characterize a system's performance capabilities or robustness.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. Nothing in this document is to be construed as an admission that the embodiments described in this document are not entitled to antedate such disclosure by virtue of prior invention. As used herein, the term “comprising” means “including, but not limited to.”

In an embodiment, a method of determining a maximum profit for a print production environment may include receiving, by a computing device, a flow model associated with a print production environment, applying, by the computing device, a modified Jackson Network analysis to the flow model to generate one more characteristic curves that each characterize a relationship between profit of the print production environment and job inflow rate and that each show a maximum profit value for the print production environment, and presenting, by the computing device, one or more of the generated characteristic curves to a user.

In an embodiment, a method of determining a maximum profit for a print production environment may include receiving, by a computing device, a flow model associated with a print production environment, solving a modified Jackson Network analysis associated with the flow model for one or more values of a first decision variable associated with one or more routing devices in the flow model, performing, by the computing device, one or more job processing simulations that are based on the one or more values of the first decision variable and one or more values of a second decision variable to generate one or more characteristic curves that each characterize a relationship between the second decision variable and a gross profit rate associated with the print production environment, and presenting, by the computing device, one or more of the generated characteristic curves to a user.

In an embodiment, a system of determining a maximum profit for a print production environment may include a computing device and a computer-readable storage medium in communication with the computing device. The computer-readable storage medium may include one or more programming instructions that, when executed, cause the computing device to receive a flow model associated with a print production environment, solve a modified Jackson Network analysis associated with the flow model for one or more values of a first decision variable associated with one or more routing devices in the flow model, perform one or more job processing simulations that are based on the one or more values of the first decision variable and one or more values of a second decision variable to generate one or more characteristic curves that each characterize a relationship between the second decision variable and a gross profit rate associated with the print production environment, and present one or more of the generated characteristic curves to a user.

### BRIEF DESCRIPTION OF THE DRAWINGS

FIG. 1 shows an example of a production environment according to an embodiment.

FIG. 2 illustrates an example flow model associated with a production environment according to an embodiment.

FIG. 3 illustrates an example method of determining the profitability of an open-loop production environment according to an embodiment.

FIG. 4 illustrates an example theoretical characteristic curve according to an embodiment.

FIG. 5 illustrates an example simulated characteristic curve according to an embodiment.

FIG. 6 illustrates an example method of determining the profitability of a closed-loop production environment according to an embodiment.

FIG. 7 illustrates an example characteristic curve according to an embodiment.

FIG. 8 illustrates a block diagram of example hardware that may be used to contain or implement program instructions according to an embodiment.

### DETAILED DESCRIPTION

The following terms shall have, for purposes of this application, the respective meanings set forth below:

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

A “job” refers to a logical unit of work that is to be completed for a customer. For example, in a print production environment, a job may include one or more print jobs from one or more clients. For example, a job in a vehicle production environment may include manufacturing a vehicle or a portion thereof. As another example, a job in a chemical production environment may include producing or processing a chemical product or a portion thereof. Similarly, a job in a computing device production environment may be to manufacture a computing device or a portion thereof such as, for example, a printer, a scanner or a copier.

A “print job” refers to a job processed in a print shop. For example, a print job may include producing credit card statements corresponding to a certain credit card company, producing bank statements corresponding to a certain bank, printing a document, or the like. Although the disclosed embodiments pertain to print jobs, the disclosed methods and systems can be applied to jobs in general in other production environments, such as automotive manufacturing, semiconductor production and the like.

A “production environment” refers to machine and/or human labor used to complete one or more jobs. A production environment may include one or more devices or other equipment that may be used to complete one or more jobs. Example production environments may include, without limitation, a print production environment, a chemical production environment, a vehicle production environment, a computing device manufacturing production environment, and/or other manufacturing production environments.

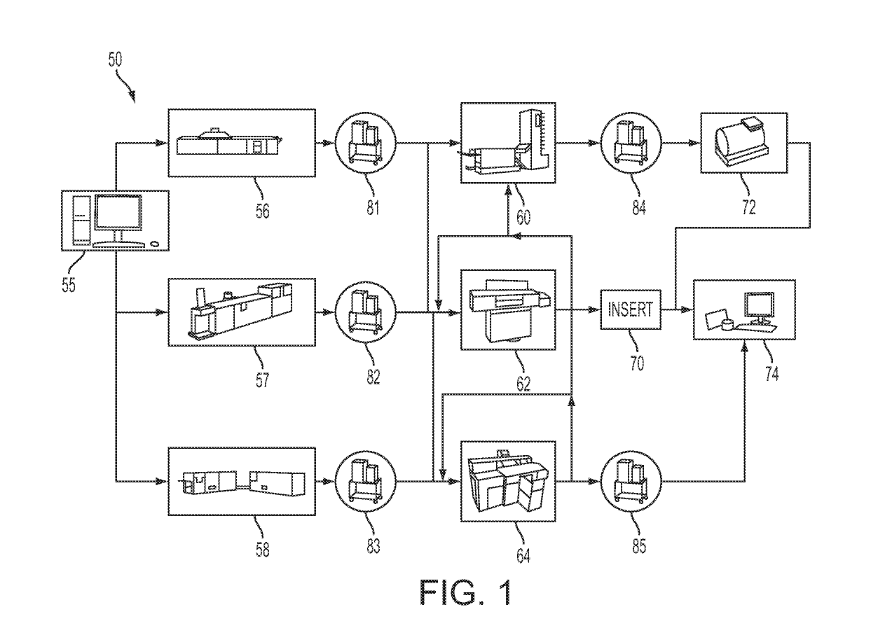

FIG. 1 shows an example of a production environment 50, in this case, example elements of a print production environment. Print jobs may enter the print shop manually or electronically and be collected at an electronic submission system 55 such as a computing device and/or scanner. Jobs are sorted and batched at the submission system or another location before being delivered to one or more print engines such as a color printer 56, black-and-white printer 57 and/or a continuous feed printer 58. Jobs may exit the print engine and be delivered to one or more finishing devices or areas such as a collator 60, cutter 62, and/or binder 64. The finishing areas may include automatic or manual areas for such finishing activities and they also may include an automatic or manual inserter 70. Finally, jobs may move to a postage metering station 72 and/or shipping station 74. Jobs may move from one location to another in the print shop by automatic delivery or manual delivery such as by hand or by one or more paper carts 81-85. Additional and/or alternate production environments may be used within the scope of this disclosure.

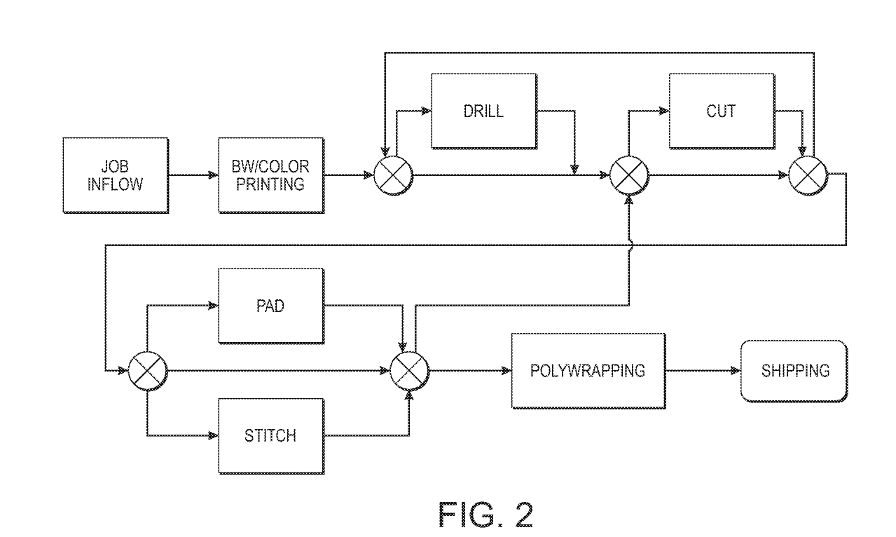

In an embodiment, the various paths a job may take through a production environment may be represented as a flow model. FIG. 2 illustrates an example flow model associated with a production environment according to an embodiment. In an embodiment, a production environment may be associated with a number of different job types. A job type may be associated with a unique path of a flow model. For example, FIG. 2 illustrates ten different paths and therefore ten different job types associated with the flow model.

In an embodiment each process or stage of a flow model may include one or more production devices that may perform the associated operation. In an embodiment, a flow model may include one or more routing devices. A routing device may be a production device that routes at least a portion of one or more jobs to one or more other production devices. One or more operating policies may be used to determine a suitable job inflow rate and/or routing policy for one or more stages. For example, a probabilistic routing policy may be used. In an embodiment, a probabilistic routing policy may assign a job as it arrives to a stage to a production device in accordance with a pre-determined standard routing approach. A probabilistic routing policy may consider processing speeds of one or more devices.

For example, referring to FIG. 2, the BW/Color Printing stage may include three production devices capable of performing black-and-white and/or color printing, Device A, Device B and Device C. Device A and Device B may have the same processing speed, and Device C may have a processing speed that is twice as fast as that of Device A and Device B. As such, a job arriving at the BW/Color Printing stage may be routed to each of Device A or Device B 25% of the time, but may be routed to Device C 50% of the time.

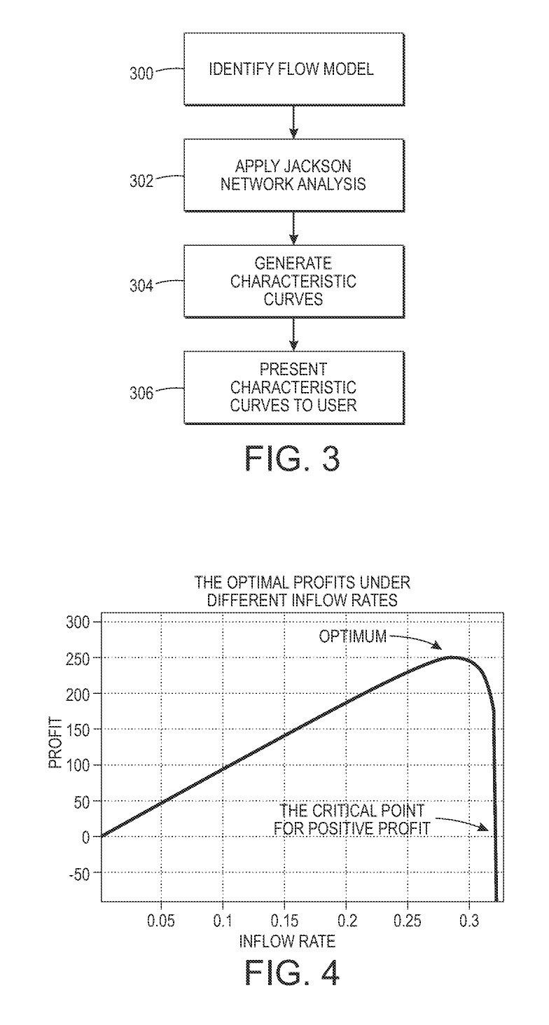

FIG. 3 illustrates an example method of determining the profitability of an open-loop production environment according to an embodiment. An open-loop system may refer to a system where jobs are released into a production environment at a steady state. As illustrated by FIG. 3, a flow model associated with a production environment may be identified 300. A modified Jackson Network analysis may be applied 302 to the flow model in an embodiment. A Jackson Network is described in more detail in at least Walrand, J.; Varaiya, P. (1980); “Soujourn Times and the Overtaking Condition in Jacksonian Networks”, Advances in Applied Probability 12(4): 1000-1018.

A profit function per unit time may be expressed as follows:

$$• p \cdot TH - {\sum }_{i} {c}_{i} \cdot {w}_{i}$$

where p is the profit rate,
TH is the throughput,
cᵢ is the cost of the work-in-process level at stage i, and
wᵢ is the corresponding work-in-process level at stage i

In an embodiment, the job inflow rate and routing probabilities at each stage may be controlled and the following assumptions may be made:
Job arrival process follows a Poisson process
Each arrival is independently routed to node j with probability

$${\sum }_{j = 1}^{j} {p}_{o j = 1}$$

All service times are independently exponentially distributed
All jobs that leave each node also follow a Poisson process

In an embodiment, at steady state, the throughput may equal the inflow rate, and the WIP level of stage i may be expressed as follows:

$$\frac{{λ}_{i} / {μ}_{i}}{1 - {λ}_{i} / {μ}_{i}} ,$$

Where λ is the job inflow rate of each production device,
μᵢ is the service rate of each production device

To maximize profit, a nonlinear programming problem (NLP) may be represented as follows:

$${max}_{λ , {θ}_{i}} J = p \cdot TH - {\sum }_{i} {c}_{i} \cdot {w}_{i}$$

$$subject to TH = λ , \\ {\sum }_{i} {c}_{i} \cdot {w}_{i} = {\sum }_{i} {c}_{{B}_{i}} \cdot \frac{λ {p}_{B} {θ}_{B}}{{μ}_{{B}_{i}} - λ {p}_{B} {θ}_{{B}_{i}}} + {\sum }_{i} {c}_{{c}_{i}} \cdot \frac{λ {p}_{C} {θ}_{{C}_{i}}}{{μ}_{{C}_{i}} - λ {p}_{C} {θ}_{{C}_{i}}} + {\sum }_{i} {c}_{{D}_{i}} \cdot \frac{λ {p}_{D} {θ}_{{D}_{i}}}{{μ}_{{D}_{i}} - λ {p}_{D} {θ}_{{D}_{i}}} + {\sum }_{i} {c}_{{Cu}_{i}} \cdot \frac{λ {p}_{Cu} {θ}_{{Cu}_{i}}}{{μ}_{{Cu}_{i}} - λ {p}_{C} {θ}_{{Cu}_{i}}} + {\sum }_{i} {c}_{{Pd}_{i}} \cdot \frac{λ {p}_{Pd} {θ}_{{Pd}_{i}}}{{μ}_{{Pd}_{i}} - λ {p}_{Pd} {θ}_{{Pd}_{i}}} + {\sum }_{i} {c}_{{St}_{i}} \cdot \frac{λ {p}_{St} {θ}_{{St}_{i}}}{{μ}_{{St}_{i}} - λ {p}_{St} {θ}_{{St}_{i}}} , \\ 0 \leq λ < min \{ \frac{{μ}_{{B}_{i}}}{{p}_{B} {θ}_{{B}_{i}}} , \frac{{μ}_{{C}_{i}}}{{p}_{C} {θ}_{{C}_{i}}} , \frac{{μ}_{{D}_{i}}}{{p}_{D} {θ}_{{D}_{i}}} , \frac{{μ}_{{Cu}_{i}}}{{p}_{Cu} {θ}_{{Cu}_{i}}} , \frac{{μ}_{{Pd}_{i}}}{{p}_{Pd} {θ}_{{Pd}_{i}}} , \frac{{μ}_{{St}_{i}}}{{p}_{St} {θ}_{{St}_{i}}} \} , \\ {\sum }_{i} {θ}_{{B}_{i}} = 1 , … , {\sum }_{i} {θ}_{{St}_{i}} = 1 , {θ}_{i} \geq 0 , \\ {p}_{B} , … , {p}_{St} given by the event log$$

Where pᵢ represents the respective portion of each job in the entire job flow,
θᵢ represents the routing probability at each stage

In an embodiment, one or more characteristic curves that characterize the relationship between profit and input may be generated 304 by solving the above NLP. In an embodiment, one or more characteristic curves may be generated 304 by solving the above NLP for different values of one or more decision variables. A decision variable may be an independent parameter whose value may affect the value of an objective function value. An objective function value may be a function involving one or more decision variables that is to be minimized or maximized. For example, using the NLP illustrated above, λ and θᵢ may be considered decision variables, and J may be considered an objective function value. In an embodiment, the value of λ may be fixed, and the NLP may be solved for the corresponding optimal routing probability, θᵢ.

In an embodiment, the decision variables and objective function value may be determined based on a control policy associated with a production environment. A control policy may indicate processing and/or routing instructions associated with a production environment. In an embodiment, the expression of an objective function may differ depending on the associated control policy because different control policies may involve different decision variables. Example control policies may include, without limitation, a constant work-in-process (CONWIP) policy, a kanban policy and/or the like.

In an embodiment, a theoretical characteristic curve may be generated 304. FIG. 4 illustrates an example theoretical characteristic curve according to an embodiment. As illustrated by FIG. 4, the theoretical characteristic curve shows a relationship between job inflow rate and profit. For example, as illustrated by FIG. 4, an inflow rate of approximately 0.28 jobs per unit time results in the highest amount of profit (i.e., approximately $250/hour).

In an embodiment, one or more simulated characteristic curves may be generated 304. A simulated characteristic curve may be generated based on one or more optimal routing probabilities determined by solving the above NLP. In an embodiment, one or more optimal routing probabilities for each device in the flow network that routes work may be determined using the above NLP. Simulated profit values may be determined by performing one or more simulations on different inflow rate values and corresponding determined optimal routing probabilities. These values may produce a simulated characteristic curve of inflow rate vs. objective value according to an embodiment.

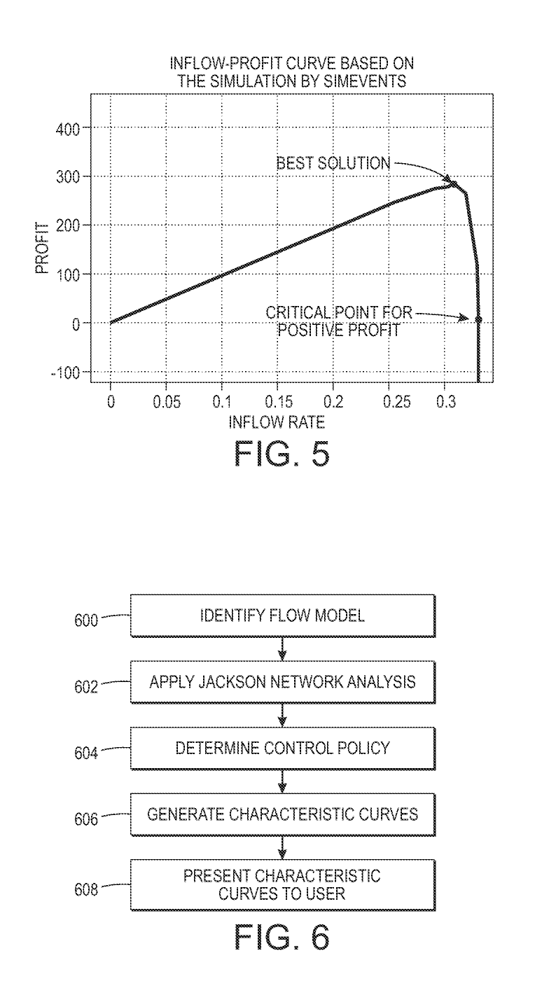

For example, FIG. 5 illustrates a simulated characteristic curve corresponding to the flow model illustrated by FIG. 1 according to an embodiment. In an embodiment, the flow model may not be subject to one or more of the above assumptions associated with the Jackson Network approach described above. For example, the flow model may only be subject to the assumption that the inflow inter-arrival time of jobs is exponentially distributed. As illustrated by FIG. 4, an inflow rate of approximately 0.32 results in the highest amount of profit (i.e., approximately $275/hour).

In an embodiment, at least a portion of the generated characteristic curves may be presented 306 to a user. At least a portion of the generated characteristic curves may be presented 306 to a user via a display device, email and/or the like. For example, a simulated characteristic curve may be displayed to a user. The user may be able to use the presented information to compare current profitability of a production environment to the simulated maximum achievable profitability to determine how well the production environment is operating. In an embodiment, a user may use the presented information to make informed decisions about inflow rates and/or routing probability to improve profitability of the production environment.

FIG. 6 illustrates an example method of determining the profitability of a closed-loop production environment according to an embodiment. A closed-loop system may refer to a system where a job is not introduced into a production environment until a job is released from the production environment. As illustrated by FIG. 6, a flow model associated with a production environment may be identified 600. A modified Jackson Network analysis may be applied 602 to the flow model in an embodiment. A Jackson Network analysis may be applied 602 to the flow model in a manner as described above.

In an embodiment, a control policy associated with a production environment may be determined 604. In an embodiment, one or more characteristic curves that characterize the relationship between profit and WIP may be generated 606 by solving the above NLP in view of the determined control policy.

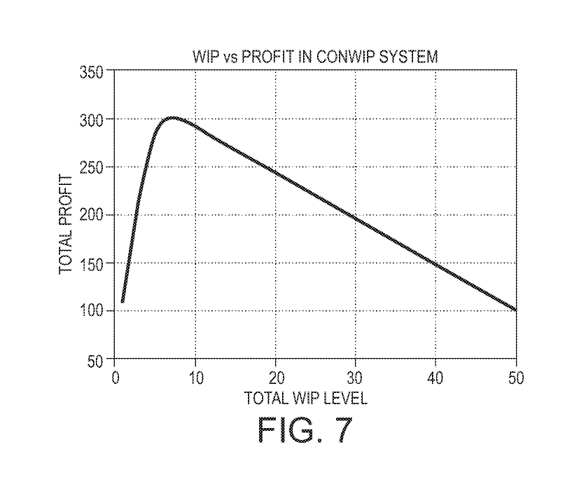

FIG. 7 illustrates an example characteristic curve for a CONWIP system according to an embodiment. As illustrated by FIG. 7, a maximum profit occurs when the WIP level is approximately 8 units.

In an embodiment, at least a portion of the generated characteristic curves may be presented 608 to a user. At least a portion of the generated characteristic curves may be presented 608 to a user via a display device, email and/or the like. For example, a characteristic curve may be displayed to a user. The user may be able to use the presented information to compare current WIP levels against a WIP level that achieves maximum profit for a production environment. A user may use this information to determine how well a production environment is operating and to more optimally control the production environment to use the best WIP level.

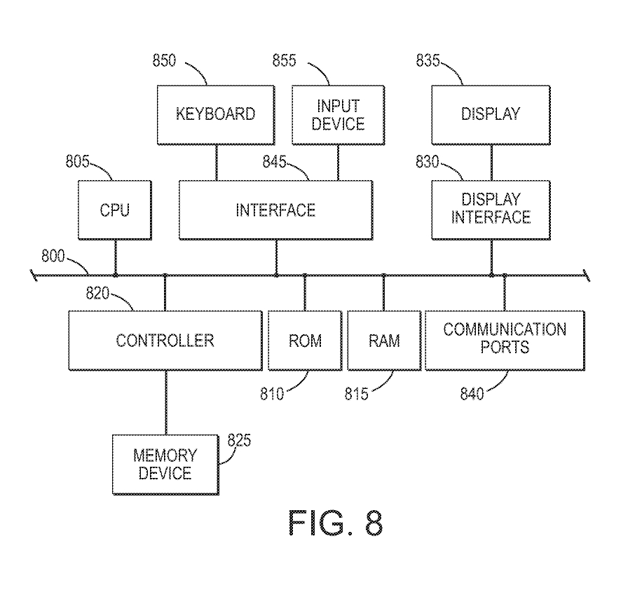

FIG. 8 depicts a block diagram of hardware that may be used to contain or implement program instructions. A bus 800 serves as the main information highway interconnecting the other illustrated components of the hardware. CPU 805 is the central processing unit of the system, performing calculations and logic operations required to execute a program. CPU 805, alone or in conjunction with one or more of the other elements disclosed in FIG. 8, is an example of a production device, computing device or processor as such terms are used within this disclosure. Read only memory (ROM) 810 and random access memory (RAM) 815 constitute examples of non-transitory computer-readable storage media.

A controller 820 interfaces with one or more optional non-transitory computer-readable storage media 825 to the system bus 800. These storage media 825 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 810 and/or the RAM 815. Optionally, the program instructions may be stored on a tangible non-transitory computer-readable medium such as a compact disk, a digital disk, flash memory, a memory card, a USB drive, an optical disc storage medium, such as a Blu-ray™ disc, and/or other recording medium.

An optional display interface 830 may permit information from the bus 800 to be displayed on the display 835 in audio, visual, graphic or alphanumeric format. Communication with external devices, such as a printing device, may occur using various communication ports 840. A communication port 840 may be attached to a communications network, such as the Internet or an intranet.

The hardware may also include an interface 845 which allows for receipt of data from input devices such as a keyboard 850 or other input device 855 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of determining a maximum profit for a print production environment, the method comprising:
receiving, by a computing device, a flow model associated with a print production environment;
applying, by the computing device, a modified Jackson Network analysis to the flow model to generate one more characteristic curves that each characterize a relationship between profit of the print production environment and job inflow rate and that each show a maximum profit value for the print production environment; and
presenting, by the computing device, one or more of the generated characteristic curves to a user.

2. The method of claim 1, wherein applying a modified Jackson Network analysis to the flow model comprises solving a non-linear programming problem represented as follows:
$${max}_{λ , {θ}_{i}} J = p \cdot TH - {\sum }_{i} {c}_{i} \cdot {w}_{i}$$
$$subject to TH = λ , \\ {\sum }_{i} {c}_{i} \cdot {w}_{i} = {\sum }_{i} {c}_{{B}_{i}} \cdot \frac{λ {p}_{B} {θ}_{B}}{{μ}_{{B}_{i}} - λ {p}_{B} {θ}_{{B}_{i}}} + {\sum }_{i} {c}_{{c}_{i}} \cdot \frac{λ {p}_{C} {θ}_{{C}_{i}}}{{μ}_{{C}_{i}} - λ {p}_{C} {θ}_{{C}_{i}}} + {\sum }_{i} {c}_{{D}_{i}} \cdot \frac{λ {p}_{D} {θ}_{{D}_{i}}}{{μ}_{{D}_{i}} - λ {p}_{D} {θ}_{{D}_{i}}} + {\sum }_{i} {c}_{{Cu}_{i}} \cdot \frac{λ {p}_{Cu} {θ}_{{Cu}_{i}}}{{μ}_{{Cu}_{i}} - λ {p}_{C} {θ}_{{Cu}_{i}}} + {\sum }_{i} {c}_{{Pd}_{i}} \cdot \frac{λ {p}_{Pd} {θ}_{{Pd}_{i}}}{{μ}_{{Pd}_{i}} - λ {p}_{Pd} {θ}_{{Pd}_{i}}} + {\sum }_{i} {c}_{{St}_{i}} \cdot \frac{λ {p}_{St} {θ}_{{St}_{i}}}{{μ}_{{St}_{i}} - λ {p}_{St} {θ}_{{St}_{i}}} , \\ 0 \leq λ < min \{ \frac{{μ}_{{B}_{i}}}{{p}_{B} {θ}_{{B}_{i}}} , \frac{{μ}_{{C}_{i}}}{{p}_{C} {θ}_{{C}_{i}}} , \frac{{μ}_{{D}_{i}}}{{p}_{D} {θ}_{{D}_{i}}} , \frac{{μ}_{{Cu}_{i}}}{{p}_{Cu} {θ}_{{Cu}_{i}}} , \frac{{μ}_{{Pd}_{i}}}{{p}_{Pd} {θ}_{{Pd}_{i}}} , \frac{{μ}_{{St}_{i}}}{{p}_{St} {θ}_{{St}_{i}}} \} , \\ {\sum }_{i} {θ}_{{B}_{i}} = 1 , … , {\sum }_{i} {θ}_{{St}_{i}} = 1 , {θ}_{i} \geq 0 , \\ {p}_{B} , … , {p}_{St} given by the event log$$
where:
p is a profit rate,
TH is a throughput,
cᵢ is a cost of the work-in-process level at stage i of the flow model,
wᵢ is a work-in-process level at stage i,
λ is a job inflow rate,
μᵢ is a service rate of one or more production devices in the print production environment,
pᵢ a respective portion of each job in the entire job flow, and
θᵢ represents a routing probability at each stage.

3. The method of claim 1, wherein applying a modified Jackson Network analysis to the flow model to generate one more characteristic curves comprises generating a theoretical characteristic curve for the flow model based using one or more of the following assumptions:
a print job arrival process follows a Poisson process;
each print job is independently routed to a node of the flow model with a certain probability;
each print production device service time is independently exponentially distributed; and
each print job that leaves each node of the flow model follows a Poisson process.

4. The method of claim 1, wherein presenting one or more of the generated characteristic curves to a user comprises presenting a graphical representation of the one or more characteristic curves to the user.

5. The method of claim 1, wherein the print production environment is an open-loop print production environment.

6. A method of determining a maximum profit for a print production environment, the method comprising:
receiving, by a computing device, a flow model associated with a print production environment;
solving a modified Jackson Network analysis associated with the flow model for one or more values of a first decision variable associated with one or more routing devices in the flow model;
performing, by the computing device, one or more job processing simulations that are based on the one or more values of the first decision variable and one or more values of a second decision variable to generate one or more characteristic curves that each characterize a relationship between the second decision variable and a gross profit rate associated with the print production environment; and
presenting, by the computing device, one or more of the generated characteristic curves to a user.

7. The method of claim 6, wherein:
solving a modified Jackson Network analysis associated with the flow model for one or more values of a first decision variable associated with one or more routing devices in the flow model comprises solving a modified Jackson Network analysis associated with the flow model for one or more values of a routing probability variable associated with one or more routing devices in the flow model;
performing one or more job processing simulations comprises running one or more job processing simulations that are based on the one or more values of the routing probability variable and one or more values of an inflow rate to generate one or more characteristic curves that each characterize a relationship between the inflow rate and a gross profit rate associated with the print production environment.

8. The method of claim 6, further comprising determining the first decision variable and the second decision variable based on a control policy associated with the print production environment.

9. The method of claim 6, wherein presenting one or more of the generated characteristic curves to a user comprises presenting one or more of the generated characteristic curves that show a maximum profit value for the print production environment to the user.

10. The method of claim 6, wherein presenting one or more of the generated characteristic curves to a user comprises presenting a graphical representation of the one or more characteristic curves to the user.

11. A system of determining a maximum profit for a print production environment, the system comprising:
a computing device; and
a computer-readable storage medium in communication with the computing device, wherein the computer-readable storage medium comprises one or more programming instructions that, when executed, cause the computing device to:
receive a flow model associated with a print production environment,
solve a modified Jackson Network analysis associated with the flow model for one or more values of a first decision variable associated with one or more routing devices in the flow model,
perform one or more job processing simulations that are based on the one or more values of the first decision variable and one or more values of a second decision variable to generate one or more characteristic curves that each characterize a relationship between the second decision variable and a gross profit rate associated with the print production environment, and
present one or more of the generated characteristic curves to a user.

12. The system of claim 11, wherein:
the one or more programming instructions that, when executed, cause the computing device to solve a modified Jackson Network analysis associated with the flow model for one or more values of a first decision variable associated with one or more routing devices in the flow model comprise one or more programming instructions that, when executed, cause the computing device to solve a modified Jackson Network analysis associated with the flow model for one or more values of a routing probability variable associated with one or more routing devices in the flow model; and
the one or more programming instructions that, when executed, cause the computing device to perform one or more job processing simulations comprise one or more programming instructions that, when executed, cause the computing device to perform one or more job processing simulations that are based on the one or more values of the routing probability variable and one or more values of an inflow rate to generate one or more characteristic curves that each characterize a relationship between the inflow rate and a gross profit rate associated with the print production environment.

13. The system of claim 11, wherein the computer-readable storage medium further comprises one or more programming instructions that, when executed, cause the computing device to determine the first decision variable and the second decision variable based on a control policy associated with the print production environment.

14. The system of claim 11, wherein the one or more programming instructions that, when executed, cause the computing device to present one or more of the generated characteristic curves to a user comprise one or more programming instructions that, when executed, cause the computing device to present one or more of the generated characteristic curves that show a maximum profit value for the print production environment to the user.

15. The system of claim 11, wherein the one or more programming instructions that, when executed, cause the computing device to present one or more of the generated characteristic curves to a user comprise one or more programming instructions that, when executed, cause the computing device to present a graphical representation of the one or more characteristic curves to the user.
